(19) United States
(12) Patent Application Publication
(10) Pub. No.: US 2021/0396923 A1
(43) Pub. Date: Dec. 23, 2021

(54) OPTICAL FILM, BACKLIGHT MODULE AND MANUFACTURING METHOD OF BACKLIGHT MODULE

(71) Applicant: NAN YA PLASTICS CORPORATION, Taipei (TW)

(72) Inventors: TE-CHAO LIAO, TAIPEI (TW); CHUN-CHE TSAO, TAIPEI (TW); REN-YU LIAO, New Taipei City (TW)

(21) Appl. No.: 17/337,603

(22) Filed: Jun. 3, 2021

(30) Foreign Application Priority Data
Jun. 17, 2020 (TW) 109120338

(51) Int. Cl. F21V 8/00; G02B 1/18; C08J 7/04; C09D 7/61; C09D 7/63; C09D 7/20; C09D 133/08

(52) U.S. Cl. CPC G02B 6/0026; G02B 1/18; C08J 7/042; C09D 7/61; C08J 2433/08; C09D 7/20; C09D 133/08; C08J 2367/02; C09D 7/63

(57) ABSTRACT

An optical film, a backlight module, and a method for manufacturing the optical film are provided. The optical film includes a quantum dot gel layer, a first shielding layer, a second shielding layer, a first plastic layer, and a second plastic layer. The first shielding layer is disposed on one side of the quantum dot gel layer. The second shielding layer is disposed on another side of the quantum dot gel layer. The first plastic layer is disposed on a side of the first shielding layer away from the quantum dot gel layer. The second plastic layer is disposed on a side of the second shielding layer away from the quantum dot gel layer. The first shielding layer and the second shielding layer are each made of a barrier coating, and the barrier coating contains water, isopropanol, sodium bicarbonate, organic acid, and acrylic.

### CROSS-REFERENCE TO RELATED PATENT APPLICATION

This application claims the benefit of priority to Taiwan Patent Application No. 109120338, filed on Jun. 17, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an optical film, and more particularly to an optical film that is capable of shielding moisture and oxygen, a backlight module, and a method for manufacturing the optical film.

### BACKGROUND OF THE DISCLOSURE

After decades of technology development in the display industry, conventional liquid crystal displays (LCD) are facing considerable challenges from the emergence of organic light emitting diode (OLED) displays having wide color gamut. Therefore, improving color gamut and vividness of displays is an inevitable direction of development. Under the technological competition, quantum dot films having increased color purity and without the requirement of changing structures of the LED panels have come into existence. The quantum dot films are manufactured through coating and attaching pure color quantum dots onto polyethylene terephthalate (PET) films, and then disposing the PET films in backlight modules.

Currently, quantum dot materials are required to be shielded from an environment with moisture and oxygen, such that the light emitting effect thereof functions normally. However, moisture and oxygen shielding ability of epoxies that are used to encapsulate resin and PET films often fail to meet the requirements. Therefore, when enhancing color gamut of the displays by using the quantum dot films, manufacturers usually add shielding films on an inner side or an outer side of the PET films, so as to block moisture and oxygen. However, this reduces the production yield and increases the manufacturing cost, making it difficult for the prices of the products to be lowered and causing the manufacturing time to be increased. In addition, in the usage of PET films, since problems associated with thick coating layers and dispersed resin are present in the manufacturing processes thereof, PET films with greater thicknesses are usually used, causing the finished products to be too thick and unsuitable for applications other than in televisions. Therefore, the usage of quantum dot technology on displays is limited.

### SUMMARY OF THE DISCLOSURE

In response to the above-referenced technical inadequacies, the present disclosure provides an optical film, a backlight module, and a method for manufacturing the optical film.

In one aspect, the present disclosure provides an optical film including a quantum dot gel layer, a first shielding layer, a second shielding layer, a first plastic layer, and a second plastic layer. The first shielding layer is disposed on one side of the quantum dot gel layer. The second shielding layer is disposed on another side of the quantum dot gel layer. The first plastic layer is disposed on a side of the first shielding layer away from the quantum dot gel layer. The second plastic layer is disposed on a side of the second shielding layer away from the quantum dot gel layer. The first shielding layer and the second shielding layer are each made of a barrier coating, and the barrier coating contains water, isopropanol, sodium bicarbonate, organic acid, and acrylic.

Preferably, based on a total weight of the barrier coating being 100 weight percent (wt %), a composition of the water is 30 wt % to 70 wt %, a composition of the isopropanol is 5 wt % to 15 wt %, a composition of the sodium bicarbonate is 5 wt % to 15 wt %, a composition of the organic acid is 5 wt % to 20 wt %, and a composition of the acrylic is 10 wt % to 30 wt %. The barrier coating is a weak acid, and a pH value of the barrier coating is between 5.0 and 6.7.

Preferably, the acrylic is selected from a group consisting of: tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

Preferably, the quantum dot gel layer contains photoinitiator, a plurality of scattering particles, mercaptan, and acrylic. Based on a total weight of the barrier coating being 100 wt %, a composition of the photoinitiator is 1 wt % to 5 wt %, a composition of the scattering particle is 10 wt % to 30 wt %, a composition of the acrylic is 20 wt % to 70 wt %, and a composition of the mercaptan is 15 wt % to 65 wt %.

Preferably, the photoinitiator is selected from a group consisting of: 1-hydroxycyclohexyl phenyl ketone, benzoyl isopropanol, tribromomethyl phenyl sulfone, and diphenyl(2,4,6-trimethylbenzoyl) phosphine oxide, the scattering particles are surface treated microbeads having a diameter of 0.5 micrometer (μm) to 20 μm that are made of acrylic, silicon dioxide, or polystyrene, and the mercaptan is selected from a group consisting of: 2,2′-(ethylenedioxy) diethanethiol, 2,2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate.

Preferably, the first plastic layer and the second plastic layer are each made of polyethylene terephthalate.

In another aspect, the present disclosure provides a backlight module including a light guide unit, at least one light emitting unit, and an optical unit. The light guide unit has a light entrance side. The at least one light emitting unit corresponds to the light entrance side. The optical unit corresponds to the light entrance side and is disposed between the light guide unit and the at least one light emitting unit. The optical unit includes a quantum dot gel layer, a first shielding layer, a second shielding layer, a first plastic layer, and a second plastic layer. The first shielding layer is disposed on one side of the quantum dot gel layer. The second shielding layer is disposed on another side of the quantum dot gel layer. The first plastic layer is disposed on a side of the first shielding layer away from the quantum dot gel layer. The second plastic layer is disposed on a side of the second shielding layer away from the quantum dot gel layer. The first shielding layer and the second shielding layer are each made of a barrier coating, and the barrier coating contains water, isopropanol, sodium bicarbonate, organic acid, and acrylic.

Preferably, based on a total weight of the barrier coating being 100 wt %, a composition of the water is 30 wt % to 70 wt %, a composition of the isopropanol is 5 wt % to 15 wt %, a composition of the sodium bicarbonate is 5 wt % to 15 wt %, a composition of the organic acid is 5 wt % to 20 wt %, and a composition of the acrylic is 10 wt % to 30 wt %. The barrier coating is a weak acid, and a pH value of the barrier coating is between 5.0 and 6.7.

Preferably, the acrylic is selected from a group consisting of: tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

Preferably, the quantum dot gel layer contains photoinitiator, a plurality of scattering particles, mercaptan, and acrylic. Based on a total weight of the barrier coating being 100 wt %, a composition of the photoinitiator is 1 wt % to 5 wt %, a composition of the scattering particle is 10 wt % to 30 wt %, a composition of the acrylic is 20 wt % to 70 wt %, and a composition of the mercaptan is 15 wt % to 65 wt %.

Preferably, the photoinitiator is selected from a group consisting of: 1-hydroxycyclohexyl phenyl ketone, benzoyl isopropanol, tribromomethyl phenyl sulfone, and diphenyl(2,4,6-trimethylbenzoyl) phosphine oxide, the scattering particles are surface treated microbeads having a diameter of 0.5 μm to 20 μm that are made of acrylic, silicon dioxide, or polystyrene, and the mercaptan is selected from a group consisting of: 2,2′-(ethylenedioxy) diethanethiol, 2,2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate.

Preferably, the first plastic layer and the second plastic layer are each made of polyethylene terephthalate.

In yet another aspect, the present disclosure provides a method for manufacturing an optical film including: coating a barrier coating on a first plastic layer; coating the barrier coating on a second plastic layer; disposing a quantum dot gel layer on the second plastic layer, so that the barrier coating on the second plastic layer is attached to the quantum dot gel layer; disposing the first plastic layer on the quantum dot gel layer, so that the barrier coating on the first plastic layer is attached to the quantum dot gel layer; and performing a curing process to cure the barrier coating on the first plastic layer and the second plastic layer, so as to form a first shielding layer between the first plastic layer and the quantum dot gel layer, and form a second shielding layer between the second plastic layer and the quantum dot gel layer. The barrier coating contains water, isopropanol, sodium bicarbonate, organic acid, and acrylic.

Preferably, based on a total weight of the barrier coating being 100 wt %, a composition of the water is 30 wt % to 70 wt %, a composition of the isopropanol is 5 wt % to 15 wt %, a composition of the sodium bicarbonate is 5 wt % to 15 wt %, a composition of the organic acid is 5 wt % to 20 wt %, and a composition of the acrylic is 10 wt % to 30 wt %. The barrier coating is a weak acid, and a pH value of the barrier coating is between 5.0 and 6.7.

Preferably, the acrylic is selected from a group consisting of: tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

Preferably, the quantum dot gel layer contains photoinitiator, a plurality of scattering particles, mercaptan, and acrylic. Based on a total weight of the barrier coating being 100 wt %, a composition of the photoinitiator is 1 wt % to 5 wt %, a composition of the scattering particle is 10 wt % to 30 wt %, a composition of the acrylic is 20 wt % to 70 wt %, and a composition of the mercaptan is 15 wt % to 65 wt %.

Preferably, the photoinitiator is selected from a group consisting of: 1-hydroxycyclohexyl phenyl ketone, benzoyl isopropanol, tribromomethyl phenyl sulfone, and diphenyl(2,4,6-trimethylbenzoyl) phosphine oxide, the scattering particles are surface treated microbeads having a diameter of 0.5 μm to 20 μm that are made of acrylic, silicon dioxide, or polystyrene, and the mercaptan is selected from a group consisting of: 2,2′-(ethylenedioxy) diethanethiol, 2,2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate.

Preferably, the first plastic layer and the second plastic layer are each made of polyethylene terephthalate.

One of the beneficial effects of the optical film of the present disclosure is that the optical film is capable of achieving the effect of shielding moisture and oxygen through the technical solutions of “the first shielding layer disposed on one side of the quantum dot gel layer”, “the second shielding layer disposed on another side of the quantum dot gel layer”, and “the first shielding layer and the second shielding layer each being made of the barrier coating, and the barrier coating containing water, isopropanol, sodium bicarbonate, organic acid, and acrylic”.

One of the beneficial effects of the backlight module of the present disclosure is that the backlight module is capable of achieving the effect of shielding moisture and oxygen through the technical solutions of “the first shielding layer disposed on one side of the quantum dot gel layer”, “the second shielding layer disposed on another side of the quantum dot gel layer”, and “the first shielding layer and the second shielding layer each being made of the barrier coating, and the barrier coating containing water, isopropanol, sodium bicarbonate, organic acid, and acrylic”.

One of the beneficial effects of the method for manufacturing the optical film of the present disclosure is that the method is capable of achieving the effect of shielding moisture and oxygen through the technical solutions of “coating the barrier coating on the first plastic layer”, “coating the barrier coating on the second plastic layer”, “disposing the quantum dot gel layer on the second plastic layer, so that the barrier coating on the second plastic layer is attached to the quantum dot gel layer”, “disposing the first plastic layer on the quantum dot gel layer, so that the barrier coating on the first plastic layer is attached to the quantum dot gel layer”, “performing the curing process to cure the barrier coating on the first plastic layer and the second plastic layer, so as to form the first shielding layer between the first plastic layer and the quantum dot gel layer, and form the second shielding layer between the second plastic layer and the quantum dot gel layer”, and “the barrier coating containing water, isopropanol, sodium bicarbonate, organic acid, and acrylic”.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a first flowchart showing a method for manufacturing an optical film in a first embodiment of the present disclosure.

FIG. 2 is a schematic view showing step S51 of the method for manufacturing the optical film in the first embodiment of the present disclosure.

FIG. 3 is a schematic view showing step S52 of the method for manufacturing the optical film in the first embodiment of the present disclosure.

FIG. 4 is a schematic view showing step S53 of the method for manufacturing the optical film in the first embodiment of the present disclosure.

FIG. 5 is a schematic view showing step S54 of the method for manufacturing the optical film in the first embodiment of the present disclosure.

FIG. 6 is a structural schematic view of the optical film in the first embodiment of the present disclosure.

FIG. 7 is a second flowchart showing the method for manufacturing the optical film in the first embodiment of the present disclosure.

FIG. 8 is a structural schematic view of a backlight module in a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

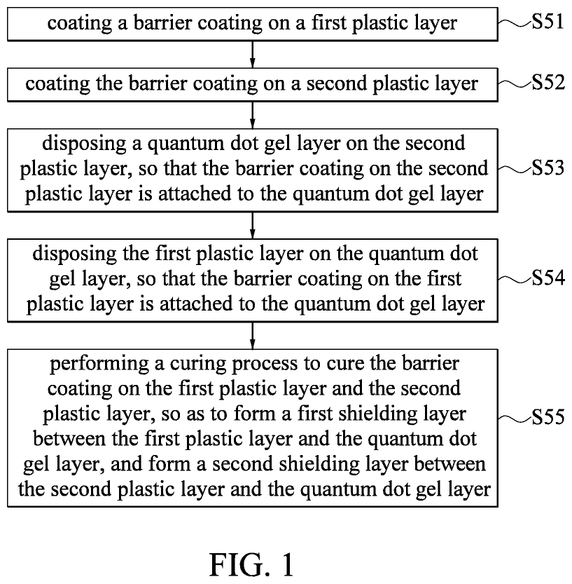

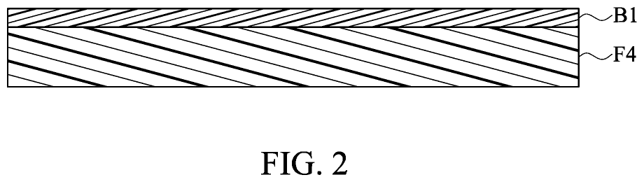

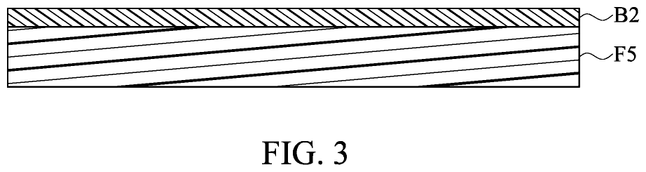

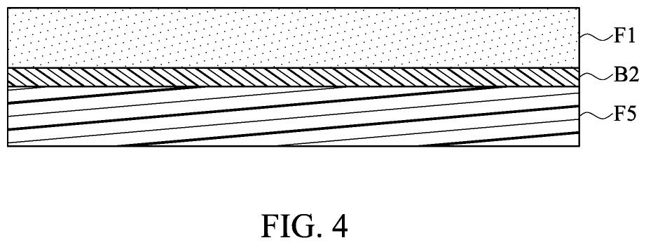

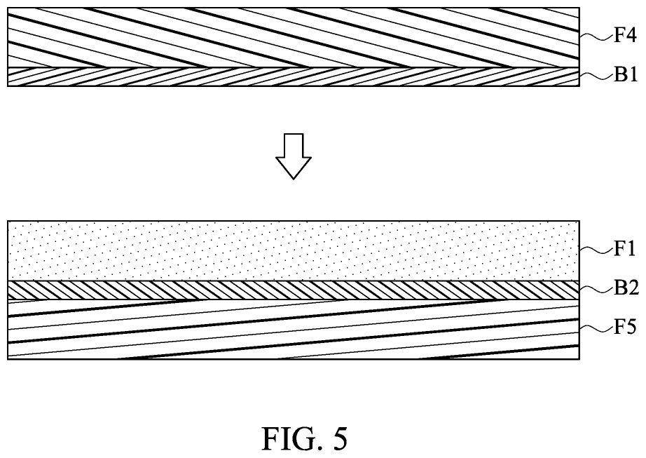

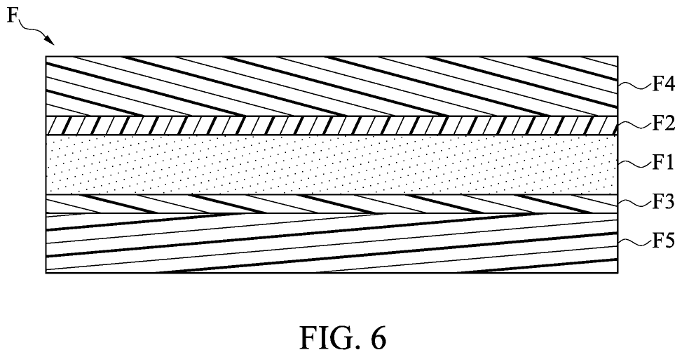

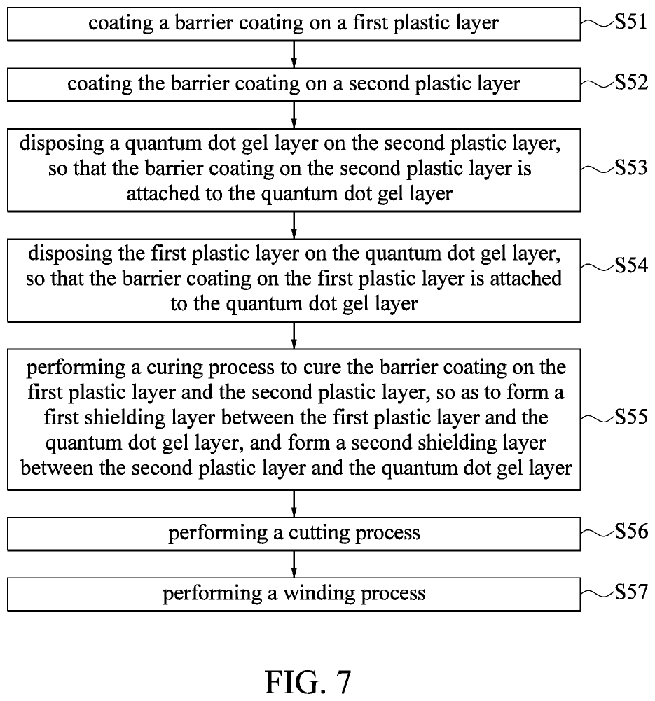

References are made to FIG. 1 to FIG. 7. FIG. 1 is a first flowchart showing a method for manufacturing an optical film in a first embodiment of the present disclosure. FIG. 2 is a schematic view showing step S51 of the method for manufacturing the optical film in the first embodiment of the present disclosure. FIG. 3 is a schematic view showing step S52 of the method for manufacturing the optical film in the first embodiment of the present disclosure. FIG. 4 is a schematic view showing step S53 of the method for manufacturing the optical film in the first embodiment of the present disclosure. FIG. 5 is a schematic view showing step S54 of the method for manufacturing the optical film in the first embodiment of the present disclosure. FIG. 6 is a structural schematic view of the optical film in the first embodiment of the present disclosure. FIG. 7 is a second flowchart showing the method for manufacturing the optical film in the first embodiment of the present disclosure. As shown in the figures, a method for manufacturing an optical film F is provided in the first embodiment of the present disclosure, the method including the following steps:

step S51: coating a barrier coating on a first plastic layer;

step S52: coating the barrier coating on a second plastic layer;

step S53: disposing a quantum dot gel layer on the second plastic layer and attaching the barrier coating on the second plastic layer to the quantum dot gel layer;

step S54: disposing the first plastic layer on the quantum dot gel layer and attaching the barrier coating on the first plastic layer to the quantum dot gel layer; and

step S55: performing a curing process to cure the barrier coating on the first plastic layer and the second plastic layer, so as to form a first shielding layer between the first plastic layer and the quantum dot gel layer, and form a second shielding layer between the second plastic layer and the quantum dot gel layer.

Firstly, in step S51, a barrier coating B1 is coated on a first plastic layer F4. For example, as shown in FIG. 1 and FIG. 2, a material of the first plastic layer F4 can be polyethylene terephthalate (PET), and the barrier coating B1 can include water, isopropanol (IPA), sodium bicarbonate, organic acid, mercaptan, and acrylic, but the present disclosure is not limited thereto. The barrier coating B1 can be formed on the first plastic layer F4 through coating and then undergo a drying process.

Next, in step S52, a barrier coating B2 is coated on a second plastic layer F5. For example, as shown in FIG. 1 and FIG. 3, a material of the second plastic layer F5 can be PET, and the barrier coating B2 can include water, IPA, sodium bicarbonate, organic acid, mercaptan, and acrylic, but the present disclosure is not limited thereto. The barrier coating B2 can be formed on the second plastic layer F5 through coating and then undergo a drying process.

It should be noted that, for the above-mentioned barrier coating B1 and barrier coating B2, based on a total weight of the barrier coating B1 or B2 being 100 weight percent (wt %), a composition of the water can be 30 wt % to 70 wt %, a composition of the IPA can be 5 wt % to 15 wt %, a composition of the sodium bicarbonate can be 5 wt % to 15 wt %, a composition of the organic acid can be 5 wt % to 20 wt %, and a composition of the acrylic can be 10 wt % to 30 wt %. The barrier coating B1 or B2 can be a weak acid, and a pH value thereof can be between 5.0 and 6.7.

Furthermore, the acrylic can be selected from a group consisting of:

tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

Next, in step S53, a quantum dot gel layer F1 is disposed on the second plastic layer F5, and the barrier coating B2 on the second plastic layer F5 is attached to the quantum dot gel layer F1. For example, as shown in FIG. 1 and FIG. 4, the quantum dot gel layer F1 can include quantum dot gel, but the present disclosure is not limited thereto. The quantum dot gel is arranged on the barrier coating B2 on the second plastic layer F5 through coating or other manner of applying, such that the barrier coating B2 is on one surface of the quantum dot gel layer F1.

Next, in step S54, the first plastic layer F4 is disposed on the quantum dot gel layer F1, and the barrier coating B1 on the first plastic layer F4 is attached to the quantum dot gel layer F1. For example, as shown in FIG. 1 and FIG. 5, the first plastic layer F4 disposed with the barrier coating B1 is disposed above the quantum dot gel layer F1, and the barrier coating B1 under the first plastic layer F4 is attached to the quantum dot gel layer F1 on a relatively upper side thereof; that is, the barrier coating B1 is attached to another surface of the quantum dot gel layer F1.

Next, in step S55, a curing process is performed to cure the barrier coating B1 and the barrier coating B2 on the first plastic layer F4 and the second plastic layer F5, respectively, so as to form a first shielding layer F2 between the quantum dot gel layer F1 and the first plastic layer F4, and form a second shielding layer F3 between the quantum dot gel layer F1 and the second plastic layers F5. For example, as shown in FIG. 1 and FIG. 6, the first shielding layer F2 and the second shielding layer F3 are respectively formed on two opposite sides of the quantum dot gel layer F1 through performing the curing process (e.g., thermal curing, but the present disclosure is not limited thereto) that cure the barrier coating B1 and the barrier coating B2, so as to form the optical film F of the present disclosure, thereby achieving the effect of protecting the quantum dot gel layer F1.

Accordingly, the optical film F provided by the present disclosure through the above technical solution improves the overall formulation of the conventional quantum dot film, which enhances moisture and oxygen shielding ability of the optical film F, without the requirement of additional barrier films. In addition, the first shielding layer F2 and the second shielding layer F3 of the present disclosure can also be coated or attached to a thinner PET film to reduce an overall thickness of the optical film F, thereby increasing the scope of application.

Furthermore, the quantum dot gel layer F1 of the optical film F of the present disclosure can contain photoinitiator, a plurality of scattering particles, mercaptan, and acrylic. Based on a total weight of the barrier coating being as 100 weight percent (wt %), a composition of the photoinitiator can be 1 wt % to 5 wt %, a composition of the scattering particle can be 10 wt % to 30 wt %, a composition of the acrylic can be 20 wt % to 70 wt %, and a composition of the mercaptan can be 15 wt % to 65 wt %. The photoinitiator can be selected from a group consisting of: 1-hydroxycyclohexyl phenyl ketone, benzoyl isopropanol, tribromomethyl phenyl sulfone, and diphenyl(2,4,6-trimethylbenzoyl) phosphine oxide. The scattering particles are surface treated microbeads having a diameter of 0.5 micrometer (μm) to 20 μm that are made of acrylic, silicon dioxide, or polystyrene. The mercaptan can be selected from a group consisting of: 2,2′-(ethylenedioxy) diethanethiol, 2,2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate. The acrylic can be selected from a group consisting of: tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

Furthermore, as shown in Table 1 down below, Table 1 shows different compositions of mercaptan and acrylic in the quantum dot gel layer F1 of the present disclosure and testing data thereof. Preferably, for the optical film F, the ratio of mercaptan to acrylic in the quantum dot gel layer F1 of the present disclosure can be 3:7, 5:5, or 6:4.

TABLE 1

| | | UV | | | | |
|---|---|---|---|---|---|---|
| Mercaptan | Acrylic | intensity | Physical | Environmental | Optical | |
| (wt %) | (wt %) | (mj/cm²) | properties | testing | properties | Adhesion |
| 15 | 70 | 1200 | Too soft | Fail | Fair | Fair |
| 35 | 50 | 700 | Preferable | Pass | Preferable | Preferable |
| 55 | 30 | 500 | Too hard | Pass | Preferable | Preferable |
| 65 | 20 | 1000 | Too hard | Fail | Fair | Preferable |

In Table 1, the testing data and measurements are further described as follows: UV intensity: measured by an UV intensity sensor; adhesion: measured through clamping and pulling apart the first shielding layer F2 or the second shielding layer F3 from the quantum dot gel layer F1 by a tensile machine; physical properties of optical film; measured by setting the bending angle of a bending machine and then starting the bending machine; optical properties: measured through having a backlight module shining the optical film F and then measuring the values by a luminance meter; and environmental testing: tested through setting an environmental testing box to a condition of 65° C. and 95% relative humidity, and taking the optical film F out of the environmental testing box every 250 hours for the above test.

In addition, as shown in FIG. 7, the method for manufacturing the optical film F of the present disclosure further includes the following steps:

step S56: performing a cutting process to cut a part of the optical film F into at least one optical film having a required size; and

step S57: performing a winding process to wind up the remaining part of the optical film F for storage.

According to the above implementations, an optical film F is also provided in the present disclosure, the optical film F includes a quantum dot gel layer F1, a first shielding layer F2, a second shielding layer F3, a first plastic layer F4, and a second plastic layer F5. The first shielding layer F2 is disposed on one side of the quantum dot gel layer F1. The second shielding layer F3 is disposed on another side of the quantum dot gel layer F1. The first plastic layer F4 is disposed on a side of the first shielding layer F2 facing away from the quantum dot gel layer F1. The second plastic layer F5 is disposed on a side of the second shielding layer F3 facing away from the quantum dot gel layer F1. The first shielding layer F2 and the second shielding layer F3 are respectively formed by barrier coating B1 and barrier coating B2. The barrier coating B1 and the barrier coating B2 respectively contains water, IPA, sodium bicarbonate, organic acid, mercaptan, and acrylic.

However, the above-mentioned example is only one of the feasible implementations, and is not meant to limit the scope of the present disclosure.

### Second Embodiment

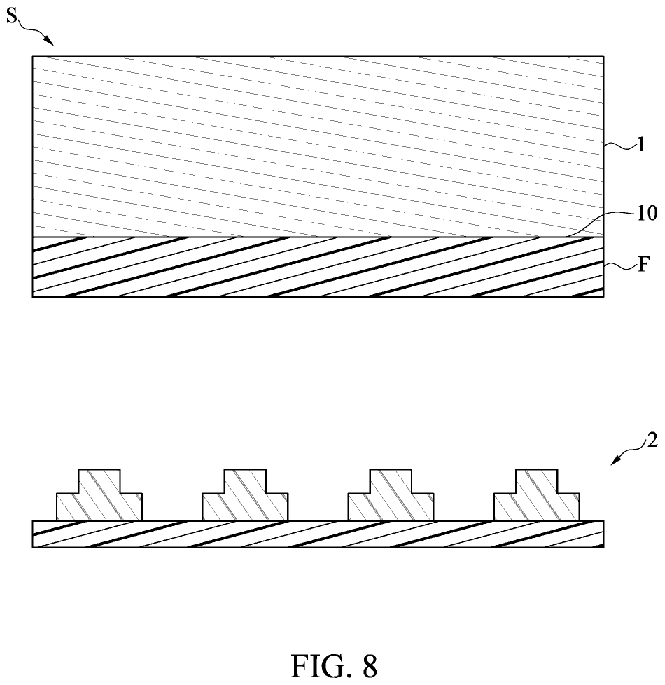

Reference is made to FIG. 8, and is to be read in conjunction with FIG. 1 to FIG. 7. FIG. 8 is a structural schematic view of a backlight module in the second embodiment of the present disclosure. As shown in the figures, a backlight module S is provided in the second embodiment of the present disclosure, the backlight module S includes a light guide unit 1, at least one light emitting unit 2, and an optical unit. The light guide unit includes a light entrance side 10. The at least one light emitting unit 2 corresponds to the light entrance side 10. The optical unit corresponds to the light entrance side 10, and the optical unit is disposed between the light guide unit 1 and the at least one light emitting unit 2. The optical unit includes a quantum dot gel layer F1, a first shielding layer F2, a second shielding layer F3, a first plastic layer F4, and a second plastic layer F5. The first shielding layer F2 is disposed on one side of the quantum dot gel layer F1. The second shielding layer F3 is disposed on another side of the quantum dot gel layer F1. The first plastic layer F4 is disposed on a side of the first shielding layer F2 facing away from the quantum dot gel layer F1. The second plastic layer F5 is disposed on a side of the second shielding layer F3 facing away from the quantum dot gel layer F1. The first shielding layer F2 and the second shielding layer F3 are respectively formed by barrier coating B1 and barrier coating B2. The barrier coating B1 and the barrier coating B2 respectively contains water, IPA, sodium bicarbonate, organic acid, and acrylic.

For example, the backlight module S provided in the second embodiment of the present disclosure includes the light guide unit 1, the at least one light emitting unit 2, and the optical unit. The light guide unit 1 can be an element with a light guide structure, the light emitting unit 2 can be a light emitting diode (LED) and can include a circuit board, and the optical unit can be the aforementioned optical film F of the present disclosure, but the present disclosure is not limited thereto. The optical unit (i.e., the optical film F) can be arranged on the light entrance side 10 of the light guide unit 1, a light emitting surface of the light emitting unit 2 corresponds to the light entrance side 10 of the light guide unit 1, and the optical film F is disposed between the light guide unit 1 and the light emitting unit 2.

As mentioned above, based on a total weight of the barrier coating B1 or the barrier coating B2 being 100 wt %, a composition of the water can be 30 wt % to 85 wt %, a composition of the IPA can be 5 wt % to 15 wt %, a composition of the sodium bicarbonate can be 5 wt % to 15 wt %, a composition of the organic acid can be 5 wt % to 20 wt %, and a composition of the acrylic can be 20 wt % to 80 wt %. The barrier coating B1 or B2 can be a weak acid.

The acrylic can be selected from a group consisting of: tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

A material of the first plastic layer F4 and the second plastic layer F5 can be PET.

However, the above-mentioned example is only one of the feasible implementations, and is not meant to limit the scope of the present disclosure.

### Beneficial Effects of the Embodiments

One of the beneficial effects of the optical film F of the present disclosure is that the optical film F is capable of achieving the effect of shielding moisture and oxygen through the technical solutions of “the first shielding layer F2 disposed on one side of the quantum dot gel layer F1”, “the second shielding layer F3 disposed on another side of the quantum dot gel layer F1”, and “the first shielding layer F2 and the second shielding layer F3 each being made of the barrier coatings B1 and B2, and each of the barrier coatings B1 and B2 containing water, isopropanol, sodium bicarbonate, organic acid, and acrylic”.

One of the beneficial effects of the backlight module of the present disclosure is that the backlight module is capable of achieving the effect of shielding moisture and oxygen through the technical solutions of “the first shielding layer F2 disposed on one side of the quantum dot gel layer F1”, “the second shielding layer F3 disposed on another side of the quantum dot gel layer F1”, and “the first shielding layer F2 and the second shielding layer F3 each being made of the barrier coatings B1 and B2, and each of the barrier coatings B1 and B2 containing water, isopropanol, sodium bicarbonate, organic acid, and acrylic”.

One of the beneficial effects of the method for manufacturing the optical film F of the present disclosure is that the method is capable of achieving the effect of shielding moisture and oxygen through the technical solutions of “coating the barrier coating B1 on the first plastic layer F4”, “coating the barrier coating B2 on the second plastic layer F5”, “disposing the quantum dot gel layer F1 on the second plastic layer F5, so that the barrier coating on the second plastic layer F5 is attached to the quantum dot gel layer F1”, “disposing the first plastic layer F4 on the quantum dot gel layer F1, so that the barrier coating B1 of the first plastic layer F4 is attached to the quantum dot gel layer F1”, “performing the curing process to cure the barrier coatings B1 and B2 on the first plastic layer F4 and the second plastic layer F5, so as to form the first shielding layer F2 between the first plastic layer F4 and the quantum dot gel layer F1, and form the second shielding layer F3 between the second plastic layer F5 and the quantum dot gel layer F1”, and “each of the barrier coatings B1 and B2 containing water, isopropanol, sodium bicarbonate, organic acid, and acrylic”.

Furthermore, the optical film F, the backlight module S, and the method for manufacturing the optical film F provided by the present disclosure adopt PET material that are suitably extended through the above-mentioned technical solutions, so as to reduce the moisture and oxygen transmittance of the first plastic layer F4 and the second plastic layer F5. In addition, the quantum dot gel layer F1 has an enhanced shielding ability, an enhanced bonding between the quantum dot gel layer F1 and the barrier coating B1, and an enhanced bonding between the quantum dot gel layer F1 and the barrier coating B2, through having the first plastic layer F4 and the second plastic layer F5 coated with the barrier coating B1 and the barrier coating B2, respectively, and the cooperation of quantum dot gel and the scattering particles of the quantum dot gel film F1. Therefore, the optical film F of the present disclosure improves the overall formulation of the conventional quantum dot films, such that the problem of shielding moisture and oxygen is solved without the requirement of additional barrier films. In addition, the first shielding layer F2 and the second shielding layer F3 of the present disclosure can also be coated or attached to a thinner PET film to reduce an overall thickness of the optical film F, thereby increasing the range of application.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical film, comprising:
a quantum dot gel layer;
a first shielding layer disposed on one side of the quantum dot gel layer;
a second shielding layer disposed on another side of the quantum dot gel layer;
a first plastic layer disposed on a side of the first shielding layer away from the quantum dot gel layer; and
a second plastic layer disposed on a side of the second shielding layer away from the quantum dot gel layer;
wherein the first shielding layer and the second shielding layer are each made of a barrier coating, and the barrier coating contains water, isopropanol, sodium bicarbonate, organic acid, and acrylic.

2. The optical film according to claim 1, wherein, based on a total weight of the barrier coating being 100 weight percent (wt %), a composition of the water is 30 wt % to 70 wt %, a composition of the isopropanol is 5 wt % to 15 wt %, a composition of the sodium bicarbonate is 5 wt % to 15 wt %, a composition of the organic acid is 5 wt % to 20 wt %, and a composition of the acrylic is 10 wt % to 30 wt %; wherein the barrier coating is a weak acid, and a pH value of the barrier coating is between 5.0 and 6.7.

3. The optical film according to claim 1, wherein the acrylic is selected from a group consisting of: tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

4. The optical film according to claim 1, wherein the quantum dot gel layer contains photoinitiator, a plurality of scattering particles, mercaptan, and acrylic; wherein, based on a total weight of the barrier coating being 100 weight percent (wt %), a composition of the photoinitiator is 1 wt % to 5 wt %, a composition of the scattering particle is 10 wt % to 30 wt %, a composition of the acrylic is 20 wt % to 70 wt %, and a composition of the mercaptan is 15 wt % to 65 wt %.

5. The optical film according to claim 4, wherein the photoinitiator is selected from a group consisting of: 1-hydroxycyclohexyl phenyl ketone, benzoyl isopropanol, tribromomethyl phenyl sulfone, and diphenyl(2,4,6-trimethylbenzoyl) phosphine oxide, and wherein the scattering particles are surface treated microbeads having a diameter of 0.5 micrometer (μm) to 20 μm that are made of acrylic, silicon dioxide, or polystyrene, and the mercaptan is selected from a group consisting of: 2,2′-(ethylenedioxy) diethanethiol, 2,2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate.

6. The optical film according to claim 1, wherein the first plastic layer and the second plastic layer are each made of polyethylene terephthalate.

7. A backlight module, comprising:
a light guide unit having a light entrance side;
at least one light emitting unit corresponding to the light entrance side; and
an optical unit corresponding to the light entrance side and disposed between the light guide unit and the at least one light emitting unit, the optical unit including:
a quantum dot gel layer;
a first shielding layer disposed on one side of the quantum dot gel layer;
a second shielding layer disposed on another side of the quantum dot gel layer;
a first plastic layer disposed on a side of the first shielding layer away from the quantum dot gel layer; and
a second plastic layer disposed on a side of the second shielding layer away from the quantum dot gel layer;
wherein the first shielding layer and the second shielding layer are each made of a barrier coating, and the barrier coating contains water, isopropanol, sodium bicarbonate, organic acid, and acrylic.

8. The backlight module according to claim 7, wherein, based on a total weight of the barrier coating being 100 weight percent (wt %), a composition of the water is 30 wt % to 70 wt %, a composition of the isopropanol is 5 wt % to 15 wt %, a composition of the sodium bicarbonate is 5 wt % to 15 wt %, a composition of the organic acid is 5 wt % to 20 wt %, and a composition of the acrylic is 10 wt % to 30 wt %; wherein, the barrier coating is a weak acid, and a pH value of the barrier coating is between 5.0 and 6.7.

9. The backlight module according to claim 7, wherein the acrylic is selected from a group consisting of: tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

10. The backlight module according to claim 7, wherein the quantum dot gel layer contains photoinitiator, a plurality of scattering particles, mercaptan, and acrylic; wherein, based on a total weight of the barrier coating being 100 weight percent (wt %), a composition of the photoinitiator is 1 wt % to 5 wt %, a composition of the scattering particle is 10 wt % to 30 wt %, a composition of the acrylic is 20 wt % to 70 wt %, and a composition of the mercaptan is 15 wt % to 65 wt %.

11. The backlight module according to claim 10, wherein the photoinitiator is selected from a group consisting of: 1-hydroxycyclohexyl phenyl ketone, benzoyl isopropanol, tribromomethyl phenyl sulfone, and diphenyl(2,4,6-trimethylbenzoyl) phosphine oxide, and wherein the scattering particles are surface treated microbeads having a diameter of 0.5 micrometer (μm) to 20 μm that are made of acrylic, silicon dioxide, or polystyrene, and the mercaptan is selected from a group consisting of: 2,2′-(ethylenedioxy) diethanethiol, 2,2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate.

12. The backlight module according to claim 7, wherein the first plastic layer and the second plastic layer are each made of polyethylene terephthalate.

13. A method for manufacturing an optical film, comprising:
coating a barrier coating on a first plastic layer;
coating the barrier coating on a second plastic layer;
disposing a quantum dot gel layer on the second plastic layer, so that the barrier coating on the second plastic layer is attached to the quantum dot gel layer;
disposing the first plastic layer on the quantum dot gel layer, so that the barrier coating on the first plastic layer is attached to the quantum dot gel layer; and
performing a curing process to cure the barrier coating on the first plastic layer and the second plastic layer, so as to form a first shielding layer between the first plastic layer and the quantum dot gel layer, and form a second shielding layer between the second plastic layer and the quantum dot gel layer;
wherein the barrier coating contains water, isopropanol, sodium bicarbonate, organic acid, and acrylic.

14. The method according to claim 13, wherein, based on a total weight of the barrier coating being 100 weight percent (wt %), a composition of the water is 30 wt % to 70 wt %, a composition of the isopropanol is 5 wt % to 15 wt %, a composition of the sodium bicarbonate is 5 wt % to 15 wt %, a composition of the organic acid is 5 wt % to 20 wt %, and a composition of the acrylic is 10 wt % to 30 wt %; wherein, the barrier coating is a weak acid, and a pH value of the barrier coating is between 5.0 and 6.7.

15. The method according to claim 13, wherein the acrylic is selected from a group consisting of: tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

16. The method according to claim 13, wherein the quantum dot gel layer contains photoinitiator, a plurality of scattering particles, mercaptan, and acrylic; wherein, based on a total weight of the barrier coating being 100 weight percent (wt %), a composition of the photoinitiator is 1 wt % to 5 wt %, a composition of the scattering particle is 10 wt % to 30 wt %, a composition of the acrylic is 20 wt % to 70 wt %, and a composition of the mercaptan is 15 wt % to 65 wt %.

17. The method according to claim 16, wherein the photoinitiator is selected from a group consisting of: 1-hydroxycyclohexyl phenyl ketone, benzoyl isopropanol, tribromomethyl phenyl sulfone, and diphenyl(2,4,6-trimethylbenzoyl) phosphine oxide, and wherein the scattering particles are surface treated microbeads having a diameter of 0.5 micrometer (μm) to 20 μm that are made of acrylic, silicon dioxide, or polystyrene, and the mercaptan is selected from a group consisting of: 2,2′-(ethylenedioxy) diethanethiol, 2,2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate.

18. The method according to claim 13, wherein the first plastic layer and the second plastic layer are each made of polyethylene terephthalate.
